(19) United States
(12) Patent Application Publication
(10) Pub. No.: US 2008/0226791 A1
(43) Pub. Date: Sep. 18, 2008

(54) Adjustable sweetener: Imovia

(76) Inventors: Enoch Ye-Shih Wang, Richmond (CA); Linda Marie-Paul Hu, Richmond (CA); Solomon Hsiu-Kung Wang, Richmond (CA)

Correspondence Address: SOLOMON WANG, 6640 MANG ROAD, RICHMOND, BC, V7C-2Y2, CA

(21) Appl. No.: 11/737,575

(22) Filed: Apr. 19, 2007

Related U.S. Application Data
(60) Provisional application No. 60/891,382, filed on Feb. 23, 2007.

(51) Int. Cl. A23L 1/236

(52) U.S. Cl. 426/548

(57) ABSTRACT

The present invention “Imovia” is a low-caloric, natural sweetener that can have adjustable levels of sweetness for use in different types of health or general food and beverages. It can be prepared in either dry or liquid form. “Imovia” combines organic or non-organic isomaltooligosaccharide (IMO), a non-digestible pre-biotic, sweet-tasting functional food, with stevia extract, a natural sweetener that can be over 300 times the sweetness of sugar, to adjust the level of sweetness.

### BACKGROUND OF THE INVENTION

It is human nature to love sweet things. From the beginning of history, people of all nations have enjoyed sweets. However, during the last century, specialists have published numerous studies on the relationship between quantities of sugar intake with various chronic diseases, particularly the detrimental effects of the presence of sugar in soft drinks have on the health of young children. In spite of such warnings, it is almost impossible for people, especially children, to refrain from enjoying sweets. At the same time, other reports have pointed out the many undesirable side effects of artificial sweeteners. Many sugar substitutes are now being used. However, the present invention proposes the use of two specific ingredients: isomalto-oligosaccharide (IMO) and extract of stevia in combination to provide a sweetener that can be produced at different levels of sweetness as required by the market.

### BRIEF SUMMARY OF THE INVENTION

“Imovia” is a low-caloric, natural sweetener that can have adjustable levels of sweetness for use in different types of health or general foods and beverages. It can be prepared in either dry or liquid form. “Imovia” combines organic or non-organic isomaltooligosaccharide (IMO), a non-digestible, pre-biotic, sweet-tasting functional food, with stevia extract, a natural sweetener that can be over 300 times the sweetness of sugar. Both ingredients have negligible effect on blood glucose level. Hence, it is suitable for diabetics. They are stable in heat and pH, and very low in calories. They are, therefore, a very desirable sugar substitute and food supplement when used in combination. They serve not only as a sweetener that can be adjusted to specified levels of sweetness as compared to sugar, but also serves as a functional food, preventing constipation and diarrhea. “Imovia” satisfies the sweet tooth, but does not cause tooth decay or obesity.

### a) Object of the Invention

In the interest of finding a way to meet the basic human desire for sweets without compromising good health, the inventors are presenting “Imovia”. This adjustable natural sweetener has a slightly fragrant smell and pleasant taste. The combination of IMO with stevia extract is to provide varying degrees of sweetness as required. The ingredients can even be made from organic substances. Vast amount of research papers have testified to the beneficial qualities of the two ingredients. But they are different, and each with their own particular set of qualities. When used in combination, they complement and enhance each other to make a perfect sugar substitute for future generations. The proposed combination not only satisfies the sweet tooth but also reduces tooth decay and gives no calories. “Imovia” can be applied to foods and beverages. When combined with fruits, grains and nuts etc., it can revolutionize the entire food and beverage industry. In the twenty-first century, people have become more health conscious, easy access provided by electronic communications have made people more knowledgeable. The general public will demand foods and drinks that heal, and not kill. The inventors believes that “Imovia” will be widely adopted in all food realms such as breads, cakes, candies, ice creams, health and power bars as well as hot and cold drinks. This invention will not only succeed in preventing poor health brought about by sugar intake, but will actually enhance the good health of those who regularly take the foods and drinks which use “Imovia”

### b) Benefits

Imovia's principle ingredient is Isomalto-oligosaccharide (IMO), which is produced by transforming starch derived from natural agricultural products such as wheat, barley, potato and corn. It can be gluten-free. IMO is now manufactured by BioNeutra Inc. in North America (see www.BioNeutra.ca) under the trademark Vitasugar™ and has been granted GRAS (Generally Regarded As Safe) status. It is a non-digestible, low-caloric sweetener. Its unique structure, due to glucose subunits that are bonded in such a way that they are resistant to digestion in human gastrointestinal tract, delivering fewer calories to the human body, and providing at the same time fiber-like health benefits as “friendly” intestinal bacteria such as Bifidobacteria readily ferment it. It is safe for the diabetic patients, being non-digestible and having little influence on blood-glucose level.

According to BioNeutra Inc., IMO is classified as a prebiotic, being found to regulate and improve the natural intestinal flora. The “friendly” intestinal bacteria, such as Bifidobacteria that are responsible for suppressing the growth of undesirable bacteria, readily ferment IMO. BioNeutra also states “Scientific studies have shown that the consumption of indigestible oligosaccharides promotes healthy peristalsis of the intestine and stomach, which can prevent and cure constipation and diarrhea.” They also claim that consumption of “IMO can reduce levels of cholesterols and blood fat.” Since IMO is non-digestible in the mouth, it helps to reduce dental cavities and is suitable for diabetic patients, as it has little influence on blood-glucose level. Isomaltooligosaccharide is mild and pleasant tasting. Being stable up to 160° C., they can be safely used for baking. Compared to sucrose, it is about 60-70% in sweetness.

The other ingredient added to Imovia is stevia extract, another natural sweetener, which can be refined to over 300% sweetness of sugar. It is also heat stable, pH stable and non-fermentable. It is available as a food supplement in US, and Canada Medical research found it useful for treating obesity and high blood pressure as a low-sugar food alternative. Stevia extract has negligible effect on blood glucose, hence also attractive to diabetic patients. Its intense and enduring sweetness when added to IMO can easily raise the sweetness of the mixture to the desired level of sweetness, far surpassing the range of natural sugars. This flexibility opens new possibilities in the field of foods and drinks.

### DETAILED DESCRIPTION OF THE INVENTION

The adjustable sweetener, “Imovia” is to use organic or non-organic isomalto-oligosaccharides (IMO) as principle ingredient, occupying up to 99.99% of the total weight of the sweetener. The other ingredient added is Stevia Extract. These ingredients complement and enhance each other, because, IMO has body and functional food qualities, but is only 60-70% in sweetness as compared with natural sugar, while stevia extract can be refined to 300 times that of the sweetness of sugar, but has little body, thus requiring fillers for most recipes. The addition of stevia extract to IMO is to attain the level of sweetness required by the food or beverage market. The percentage of weight of IMO must remain high, no less then 50% of the total weight for maintaining the functional food characteristics of this sweetener.

We claim:

1.) A product called “Imovia”, which is designed to be an adjustable, low-caloric natural sweetener, composed of organic or non-organic isomalto-oligosaccharides (IMO) as principle ingredient, occupying up to 99.99% and no less than 50% of the total weight of the sweetener and a percentage of stevia extract to meet the level of sweetness required.

2.) The product can be in either liquid or dry form.
